(19) United States
(12) Patent Application Publication
(10) Pub. No.: US 2011/0047125 A1
(43) Pub. Date: Feb. 24, 2011

(54) CONFIGURATION ITEM MANAGEMENT DEVICE AND CONFIGURATION ITEM MANAGEMENT METHOD

(75) Inventors: Yasuhide Matsumoto, Kawasaki (JP); Yuji Wada, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/916,003

(22) Filed: Oct. 29, 2010

Related U.S. Application Data
(63) Continuation of application No. PCT/JP2008/060058, filed on May 30, 2008.

(51) Int. Cl. G06F 17/30

(52) U.S. Cl. 707/609; 707/E17.005

(57) ABSTRACT

A configuration item management method includes receiving, from a logical-physical configuration database that manages a correspondence relationship between a logical configuration item database that manages a configuration item including an operation policy of an operation target device for each user and a physical configuration item database that is a physical implementation of the logical configuration item database, an input of a relevant operation policy of a user who changes the operation policy, generating a change policy by which the operation policy of the user received at the receiving is changed, and evaluating an influence that is given to an operation policy of another user by the change policy of the user generated at the generating, to determine whether to execute the change policy and to output the influence to the operation policy of the other user.

### CROSS-REFERENCE TO RELATED APPLICATION

This application is a continuation of International Application No. PCT/JP2008/060058, filed on May 30, 2008, the entire contents of which are incorporated herein by reference.

### FIELD

The embodiments discussed herein are directed to a configuration item management device and a configuration item management method.

### BACKGROUND

In recent years, a technology called SaaS (Software as a Service) is becoming widespread. SaaS means a service by which a user may selectively obtain the provision of function and program. In SaaS, a function and a program that a user (hereinafter, “tenant”) wants to use are obtained and used from a service provider by way of a network as needed, like services such as the provision of external storage area, contents delivery, or verbal communication.

SaaS is a service that is provided on the basis of an internet data center (IDC). Moreover, SaaS is a multi-tenant technology by which a physical configuration such as a server or a database may be shared by a plurality of tenants in IDC by logically dividing the physical configuration into logical components for tenants that may be individually used. Hereinafter, information defining a physical configuration is referred to as a physical configuration item and information defining a logical configuration is referred to as a logical configuration item.

A CMDB (Configuration Management Database) technology is used in multi-tenant system operation management. The CMDB is standard specification for managing the configuration items (CI) of a system, which is defined in a document called ITIL (registered trademark, Information Technology Infrastructure Library) in which know-how of success cases is accumulated. The CMDB is a configuration item database.

CMDB is a configuration item database which is a database that manages configuration items of a computer system and relationships between configuration items in order to manage configuration items (physical configuration item and logical configuration item) of the computer system.

The device configuration of a computer system includes various elements such as software or various types of data in addition to various types of hardware. The implementation of a configuration item database is referred to as MDR (Management Data Repository). Hereinafter, the physical implementation of MDR is referred to as physical MDR and the logical implementation of logically dividing or merging the physical MDR(s) is referred to as logical MDR.

An upper-hierarchy configuration item database which virtually integrates a plurality of physical MDRs and logical MDRs is referred to as FCMDB (Federated CMDB). The FCMDB virtually integrates and manages a plurality of lower-level physical MDRs and logical MDRs. This technique has been known as disclosed in, for example, Japanese Laid-open Patent Publication No. 2003-316522.

However, according to the conventional technology, under the circumstances where the number of tenants and the number of services increase and the relationships between physical configuration items and logical configuration items of IDC become complicated, problem arises when an existing logical configuration item is changed in accordance with the addition of a tenant or the modification of an operation condition of each tenant.

In other words, when a logical configuration item for a certain tenant is changed, it may have an influence on another tenant that shares physical MDR. Therefore, the logical configuration item has to be carefully changed in such a manner that it does not have an influence on the other tenant.

However, under the circumstances where the relationship among physical configuration items and logical configuration items become complicated, it is difficult to estimate an influence on another tenant and thus to change the logical configuration item.

### SUMMARY

According to an aspect of an embodiment of the invention, a configuration item management device includes: an operation policy receiving unit that receives, from a logical-physical configuration database that manages a correspondence relationship between a logical configuration item database that manages a configuration item including an operation policy of an operation target device for each user and a physical configuration item database that is a physical implementation of the logical configuration item database, an input of a relevant operation policy of a user who changes the operation policy; a change policy generating unit that generates a change policy by which the operation policy of the user received by the operation policy receiving unit is changed; and an influence evaluating/determining/outputting unit that evaluates an influence that is given to an operation policy of another user by the change policy of the user generated by the change policy generating unit, to determine whether to execute the change policy and to output the influence to the operation policy of the other user.

According to another aspect of an embodiment of the invention, a configuration item management method includes: receiving, from a logical-physical configuration database that manages a correspondence relationship between a logical configuration item database that manages a configuration item including an operation policy of an operation target device for each user and a physical configuration item database that is a physical implementation of the logical configuration item database, an input of a relevant operation policy of a user who changes the operation policy; generating a change policy by which the operation policy of the user received at the receiving is changed; and evaluating an influence that is given to an operation policy of another user by the change policy of the user generated at the generating, to determine whether to execute the change policy and to output the influence to the operation policy of the other user.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 is a schematic diagram for explaining a configuration item distribution management system according to an embodiment;

FIG. 2 is a block diagram illustrating the configuration of a configuration item management system including a configuration item management device according to a first embodiment;

FIG. 3 is a diagram illustrating an example of an operation policy;

FIG. 4 is a diagram illustrating an example of a change policy;

FIG. 5 is a schematic diagram for explaining a process of the configuration item management device according to the first embodiment;

FIG. 6 is a diagram illustrating an example of an execution flow generated in accordance with a change policy;

FIG. 7 is a flowchart illustrating the procedure of a management process of configuration items according to the first embodiment;

FIG. 8 is a block diagram illustrating the configuration of a configuration item management system including a configuration item management device according to a second embodiment;

FIG. 9 is a diagram explaining a problem that is solved by the configuration item management device according to the second embodiment; and

FIG. 10 is a flowchart illustrating the procedure of a management process of configuration items according to the second embodiment.

### DESCRIPTION OF EMBODIMENT(S)

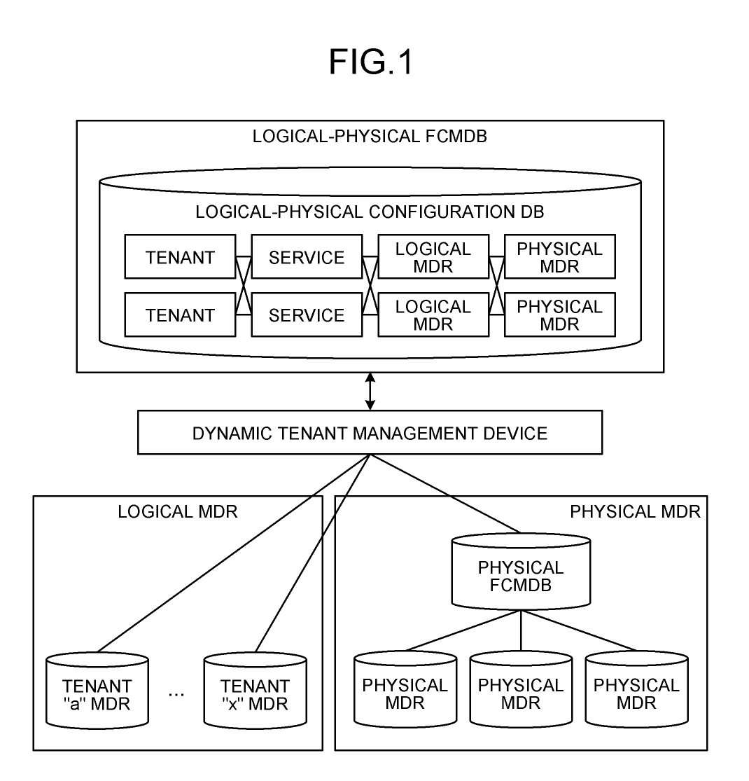

Exemplary embodiments of the present invention will be explained in detail below with reference to the accompanying drawings. The present invention is not limited to the embodiments explained below. An embodiment that is disclosed below as illustrated in FIG. 1 is based on the premise that a hierarchical distribution management system for configuration items in IDC that operates in a multi-tenant manner includes a physical FCMDB that physically integrates and manages a plurality of physical MDRs, a logical MDR for each tenant, and an upper-hierarchy logical-physical FCMDB that integrates and manages the physical FCMDB and the logical MDR.

A dynamic tenant management device that dynamically manages and executes the addition of a tenant, the change of an operation policy, and the like is arranged between “the logical-physical FCMDB” and “the physical FCMDB and the logical MDR”. When performing the change of a logical configuration item such as the addition of a tenant or the change of an operation policy in the logical MDR that shares a physical MDR, the dynamic tenant management device evaluates a change risk of a logical configuration item to determine whether to perform the change.

For example, let us call a factor having an influence on a device operation of another tenant when the logical configuration item of a certain tenant is changed a “change risk”. When it is determined that there is no “change risk”, the dynamic tenant management device generates and outputs the change flow of the logical configuration item of a tenant that corresponds to the change.

[a] First Embodiment

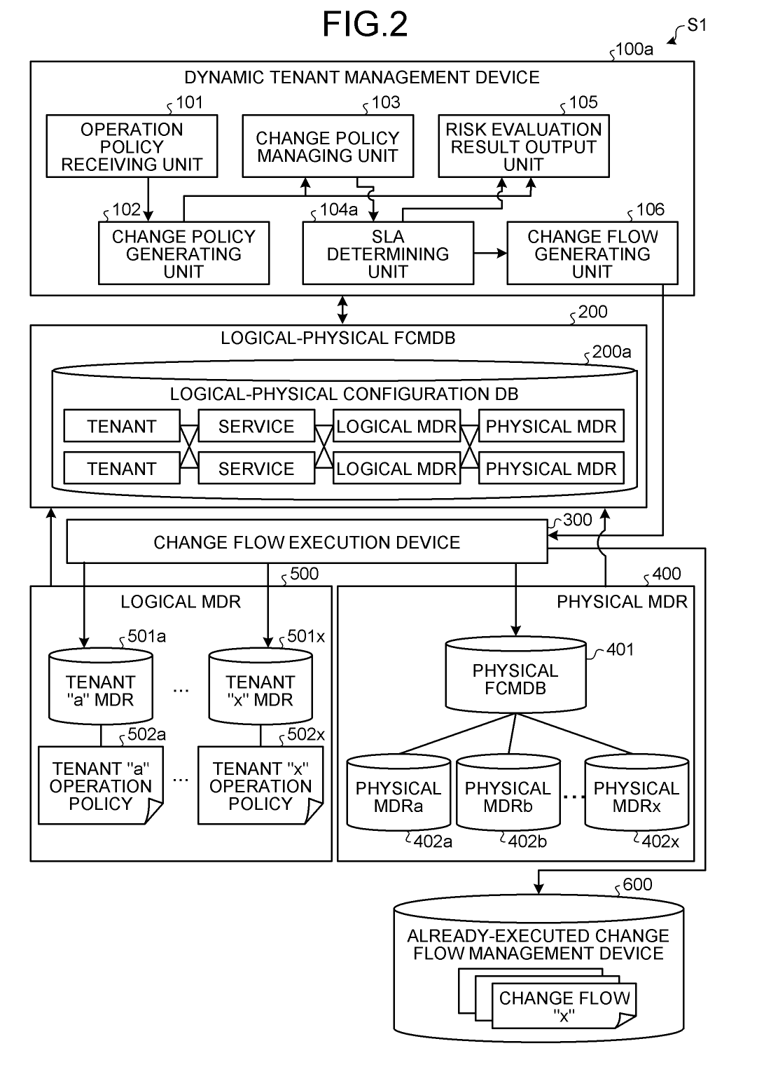

It will be explained about a configuration item management system including a configuration item management device according to the first embodiment with reference to FIGS. 2 to 7. FIG. 2 is a block diagram illustrating the configuration of a configuration item management system S1 including a configuration item management device according to the first embodiment.

As illustrated in FIG. 2, the configuration item management system S1 includes a dynamic tenant management device 100a, a logical-physical FCMDB 200, a change flow execution device 300, a physical MDR 400, a logical MDR 500, and an already-executed change flow management device 600.

The dynamic tenant management device 100a includes an operation policy receiving unit 101, a change policy generating unit 102, a change policy managing unit 103, an SLA (Service Level Agreement) determining unit 104a, a risk evaluation result output unit 105, and a change flow generating unit 106.

The operation policy receiving unit 101 receives the operation policy and the change policy of a tenant that is a change target, which is managed by the logical MDR 500. The input operation policy and change policy are transferred to the change policy generating unit 102.

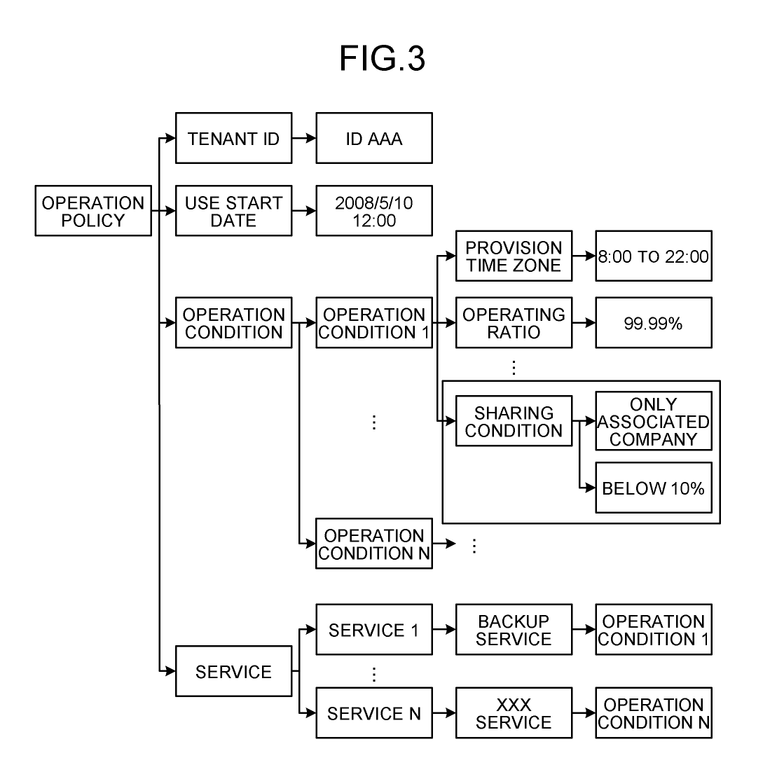

An example of an operation policy is as illustrated in FIG. 3. An operation policy includes the next information at least: (1) Tenant ID for identifying a tenant; (2) Use start date of assignment resources (including various types of hardware of a computer, a storage device, a communication device, various types of software, various types of data, and the like) that are assigned to a relevant tenant in IDC; (3) Operation condition of an assignment resource (operation condition further includes a time zone of providing a service, an operating ratio, a sharing condition of an assignment resource, and the like); and (4) Service that is provided by a relevant tenant by using an assignment resource (a service name, the type information of a service, and an operation condition are associated with each service).

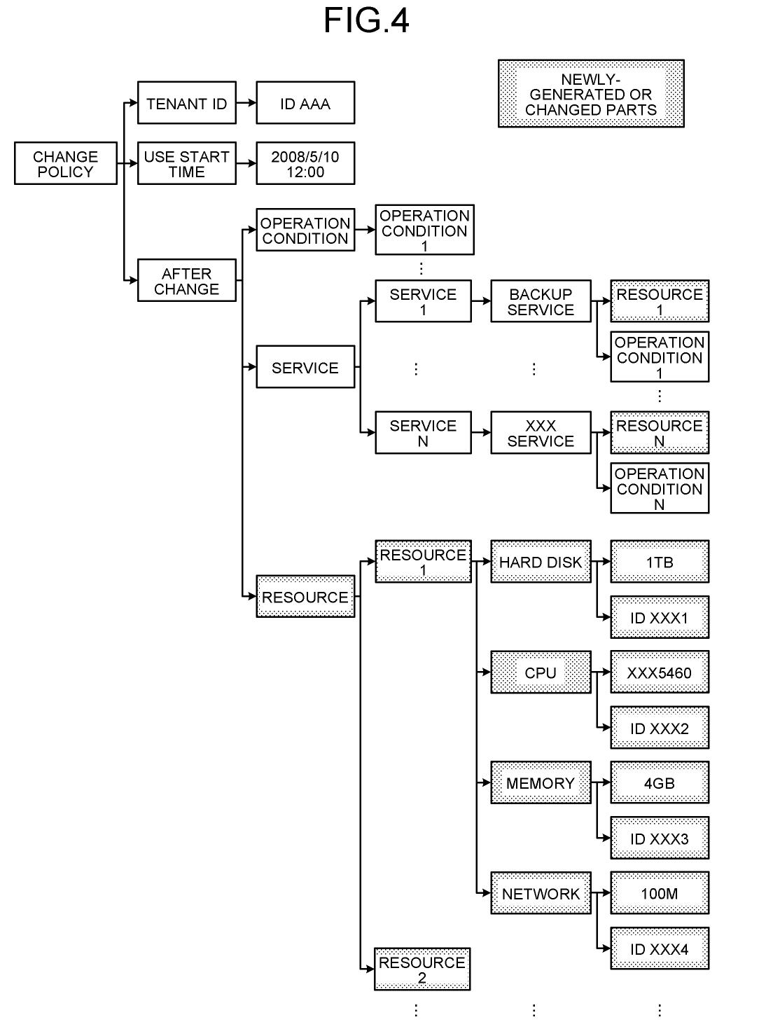

The change policy generating unit 102 generates a change policy of changing a part or the whole of an operation policy of a change target and transfers the change policy to the change policy managing unit 103 and the risk evaluation result output unit 105, based on the operation policy and the change policy transferred from the operation policy receiving unit 101. The change policy managing unit 103 is a managing unit that temporarily manages the change policy generated by the change policy generating unit 102. An example of a change policy is as illustrated in FIG. 4.

A change policy illustrated in FIG. 4 is obtained by adding resources on the basis of the operation policy illustrated in FIG. 3. Specifically, resources 1 to N are added. For example, the resource 1 is a hard disk for which a capacity and a device ID are designated, a CPU (Central Processing Unit) for which a model number and a device ID are designated, a memory for which a capacity and a device ID are designated, and a network device for which a transmission speed and a device ID are designated. The added resources are defined as resources that are respectively used for services 1 to N.

The SLA determining unit 104a takes out a change policy managed by the change policy managing unit 103 and determines whether the change of a logical configuration item by the change policy satisfies SLA exchanged with a tenant. In this case, when the change policy managing unit 103 manages a plurality of change policies, the SLA determining unit 104a determines whether SLA is satisfied for all the change policies.

For example, when SLA is “strictly keeping a service provision time prescribed in an operation policy”, the SLA is not satisfied if the change of a logical configuration item has an influence on the resource operation of another tenant that has accepted this SLA and the resource operation is stopped during the service provision time.

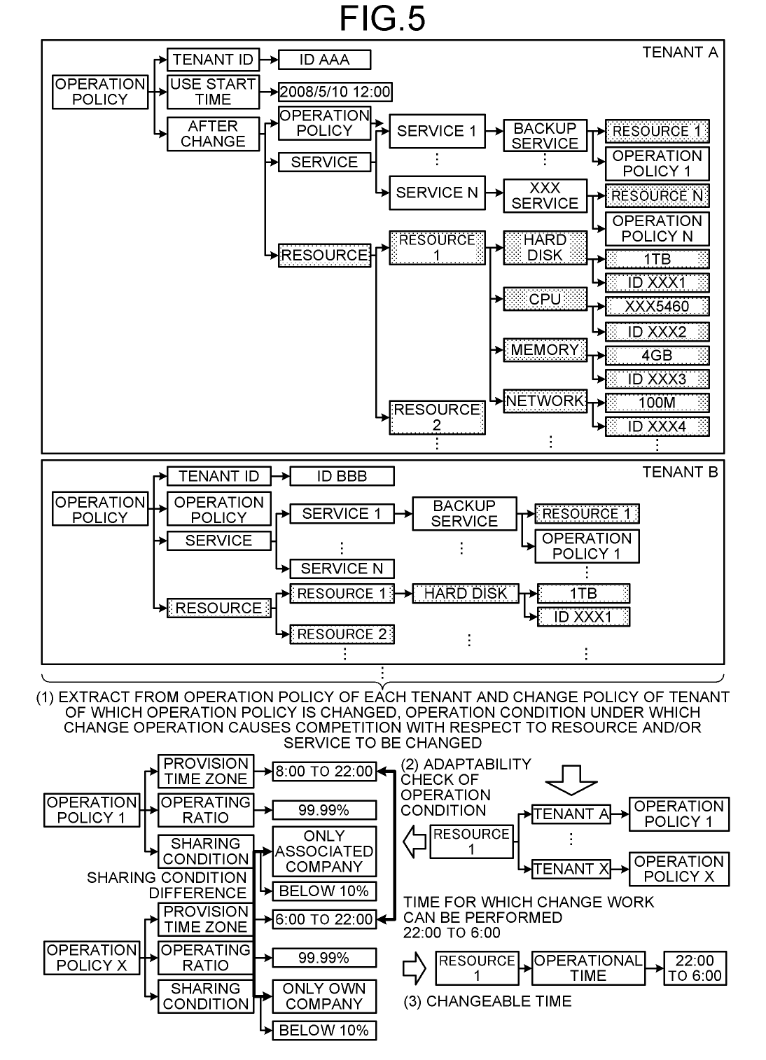

For example, as illustrated in FIG. 5, (1) the SLA determining unit 104a extracts from the operation policy of each tenant and the change policy of a tenant of which the operation policy is changed, an operation condition under which the change operation causes the competition with respect to a resource and/or a service to be changed.

Then, (2) the SLA determining unit 104a checks the adaptability of the operation condition. In this case, an item of the operation condition that is a check target is, for example, a service provision time zone and a resource sharing condition.

In an example illustrated in FIG. 5, a service provision time zone in an operation condition 1 is 8:00 to 22:00 and a service provision time zone in an operation condition X is 6:00 to 22:00. Therefore, it is determined that a time zone in which a change work of a logical configuration item may be performed is 22:00 to 6:00 (the following day).

However, in FIG. 5, the sharing conditions of the operation condition 1 and the operation condition X have a difference. (3) When it is assumed that the difference between the sharing conditions does not interfere with the change work of a logical configuration item, an operational time of changing the logical configuration item of the resource 1 is set to 22:00 to 6:00 (the following day) and it is determined that “the change risk of a logical configuration item is not present”.

In FIG. 5, when the sharing condition difference between the operation condition 1 and the operation condition X interferes with the change work of a logical configuration item and has an influence on the resource operation of another tenant, it is determined that “the change risk of a logical configuration item is present”.

It should be noted that SLA is not limited to the above. For example, SLA may be that “an operating ratio is not less than a certain constant value”. In this case, the SLA determining unit 104a determines whether there is a possibility by which SLA is not satisfied due to the fact that the change of a logical configuration item has such an influence on the resource operation of another tenant which has accepted the corresponding SLA that the resource operation stops, and thus an operating ratio decreases.

The SLA determining unit 104a transfers the evaluation result of the change risk of a logical configuration item to the risk evaluation result output unit 105. The risk evaluation result output unit 105 displays or prints the corresponding change policy transferred from the change policy generating unit 102 and the evaluation result of the change risk of the logical configuration item transferred from the SLA determining unit 104a.

Moreover, when it is determined that “the change risk of a logical configuration item is not present”, the SLA determining unit 104a transfers an operational condition such as an operational time of changing the logical configuration item, which is derived based on the change policy of a change target tenant, to the change flow generating unit 106. The change flow generating unit 106 specifies the change target tenant and generates the change flow of the logical configuration item in consideration of the operational condition.

Because an influence on the service operation of the other tenant may be avoided by considering an operational condition such as an operational time of changing a logical configuration item when the change flow is generated, the dynamic tenant management device 100a may dynamically change a logical configuration item.

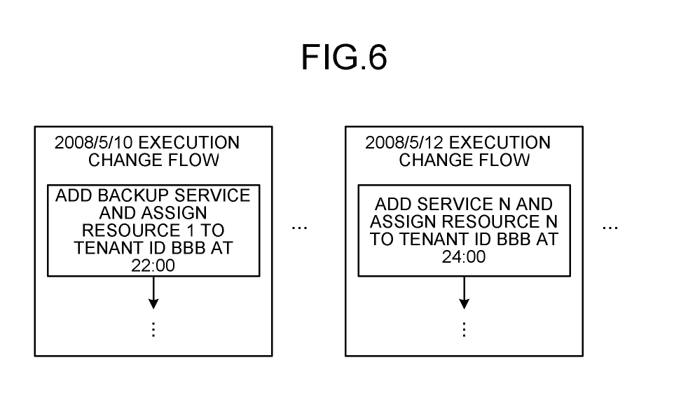

An example of a change flow is as illustrated in FIG. 6. A change flow is, for example, a flow that is obtained by specifying execution time and date, a tenant of which the logical configuration item is changed, and a service of which the logical configuration item is changed, and formulating a sequence of steps for performing a process (resource addition process) for changing a configuration item.

The logical-physical FCMDB 200 virtually integrates the physical MDR 400 and the logical MDR 500, and includes a logical-physical configuration DB 200a that manages relationships between tenants, services, logical MDRs, and physical MDRs. The dynamic tenant management device 100a acquires various types of information from the physical MDR 400 and the logical MDR 500 via the logical-physical FCMDB 200.

The change flow generated by the change flow generating unit 106 is output to the change flow execution device 300. The change flow execution device 300 performs a process (resource addition process) for changing the configuration item of the corresponding tenant on the physical MDR 400 and the logical MDR 500 in accordance with the input change flow. Then, the change flow executed by the change flow execution device 300 is stored in the already-executed change flow management device 600.

The physical MDR 400 physically integrates and manages a physical MDRa 402a to a physical MDRx 402x by using a physical FCMDB 401. The change flow by the change flow execution device 300 is performed on the physical MDRa 402a to the physical MDRx 402x via the physical FCMDB 401.

Moreover, the logical MDR 500 is MDR that is obtained by logically dividing or merging the physical MDRa 402a to the physical MDRx 402x for each tenant. The logical MDR 500 is logically divided into a tenant “a” MDR 501a to a tenant “x” MDR 501x for each tenant. Security and scalability may be secured with respect to a resource operation by logically dividing the physical MDR for each tenant.

In this case, the tenant “a” MDR 501a to the tenant “x” MDR 501x respectively include a tenant “a” operation policy 502a to a tenant “x” operation policy 502x. The operation policies are input into the operation policy receiving unit 101 of the dynamic tenant management device 100a when a logical configuration item is changed.

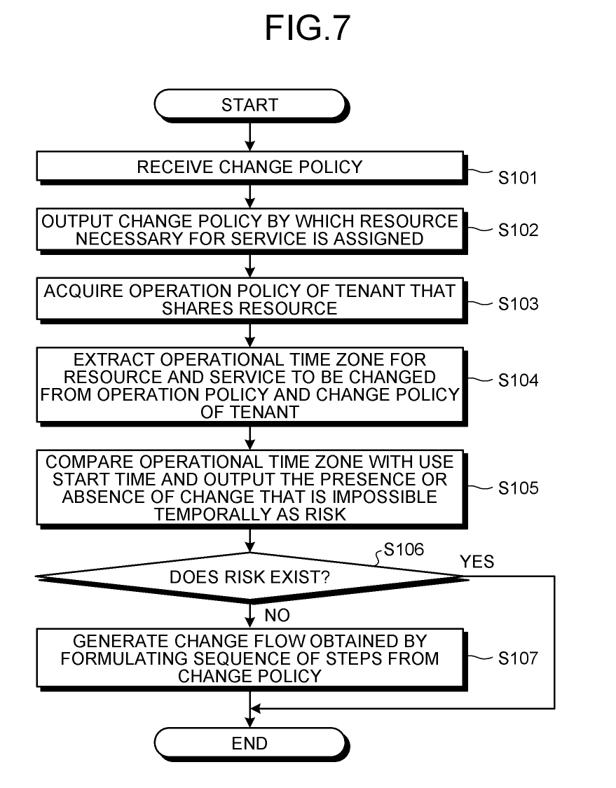

Next, it will be explained about a management process of configuration items according to the first embodiment. FIG. 7 is a flowchart illustrating the procedure of a management process of configuration items according to the first embodiment. As illustrated in FIG. 7, the operation policy receiving unit 101 first receives a change policy (Step S101).

Next, the change policy generating unit 102 outputs the change policy by which a resource is assigned for a service (Step S102). Next, the SLA determining unit 104a acquires the operation policy of a tenant that shares a resource via the logical-physical FCMDB 200 (Step S103).

Next, the SLA determining unit 104a extracts an operational time zone for a resource and a service to be changed from the operation policy and the change policy of a tenant (Step S104). Next, the SLA determining unit 104a compares, for example, the operational time zone with the use start time of another tenant, and outputs the presence or absence of a temporally-impossible change as a risk via the risk evaluation result output unit 105 (Step S105).

Next, the SLA determining unit 104a determines whether a risk exists. When it is determined that a risk exists (Step 5106: YES), the SLA determining unit 104a terminates the management process of configuration items. When it is determined that a risk does not exist (Step S106: NO), the change flow generating unit 106 generates a change flow by turning the change policy into a sequence of steps (Step S107). When Step 5107 is terminated, the management process of configuration items according to the first embodiment is terminated.

According to the management process of configuration items of the first embodiment, because the change risk of the change policy of a tenant that is a new change target is evaluated, the addition of a tenant and the addition or modification of a resource may be dynamically changed while avoiding a change risk.

[b] Second Embodiment

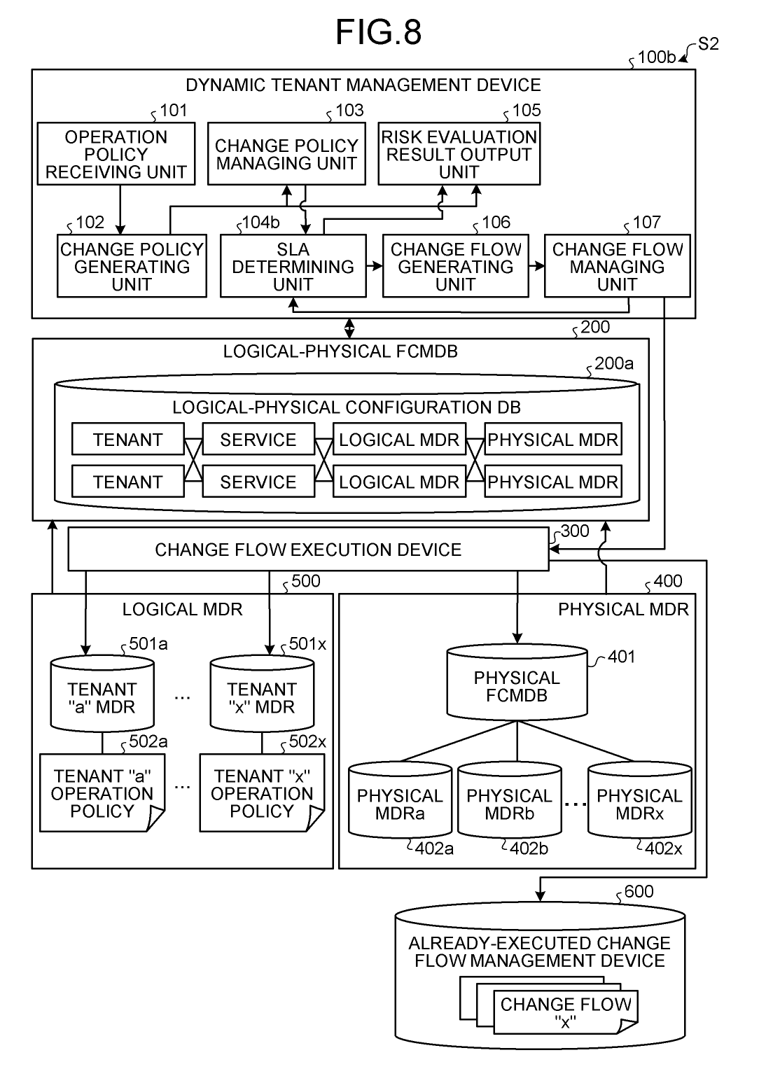

Next, it will be explained about a configuration item management system including a configuration item management device according to the second embodiment with reference to FIGS. 8 to 10. In the second embodiment, only a difference with the first embodiment is explained.

FIG. 8 is a block diagram illustrating the configuration of a configuration item management system S2 including a configuration item management device according to the second embodiment. As illustrated in FIG. 8, the configuration item management system S2 includes a dynamic tenant management device 100b in place of the dynamic tenant management device 100a. The dynamic tenant management device 100b includes a SLA determining unit 104b in place of the SLA determining unit 104a and further includes a change flow managing unit 107, compared with the dynamic tenant management device 100a.

The change flow managing unit 107 is a managing unit that temporarily manages the change flow generated by the change flow generating unit 106 before executing the change flow. When determining a change risk, the SLA determining unit 104b determines a change risk in consideration of the change flow that is temporarily managed by the change flow managing unit 107.

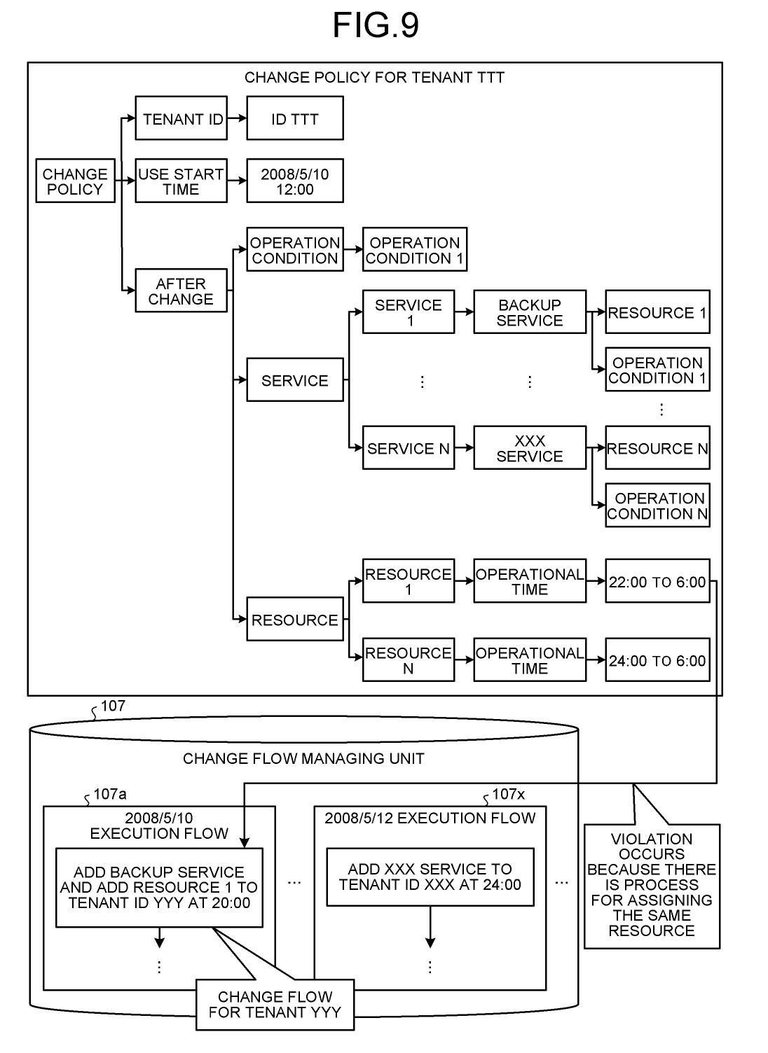

For example, as illustrated in FIG. 9, the operational time of the resource 1 of a change policy for a tenant TTT is 22:00 to 6:00 (the following day). However, if the operation is performed in this time zone, it violates a change flow 107a for a tenant YYY, among the change flow 107a to a change flow 107x that are managed by the change flow managing unit 107. The change flow 107a assigns the same resource 1 in a different time zone.

Therefore, considering the processing contents of the change flow 107a, it is found that the operational time of the resource 1 may not be set to 22:00 to 6:00 (the following day) based on the change policy for the tenant TTT.

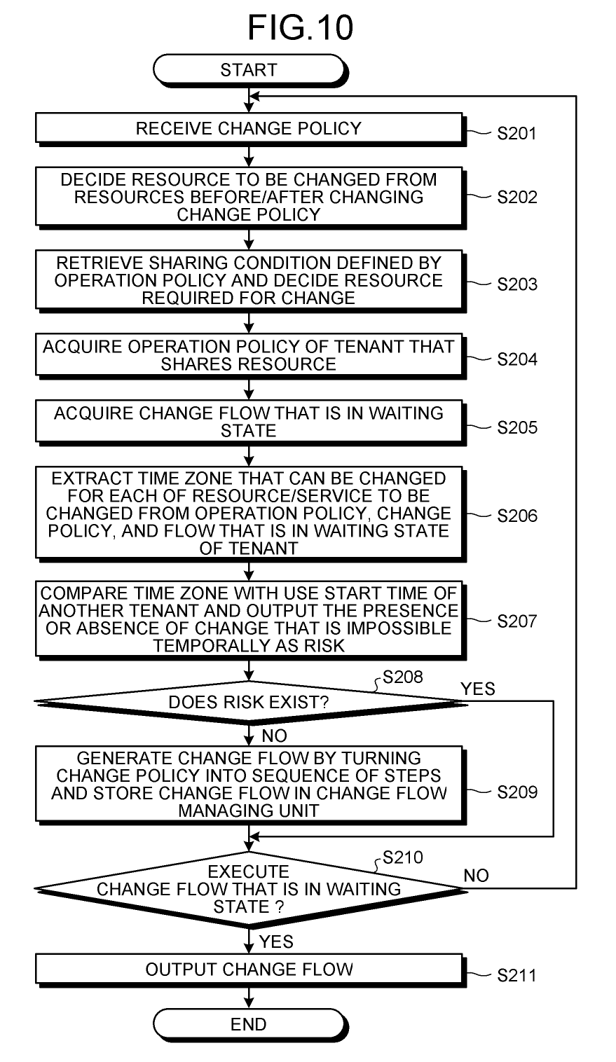

Next, it will be explained about a management process of configuration items according to the second embodiment. FIG. 10 is a flowchart illustrating the procedure of a management process of configuration items according to the second embodiment. As illustrated in FIG. 10, the operation policy receiving unit 101 first receives a change policy (Step S201).

Next, the change policy generating unit 102 decides a resource to be changed from resources before/after changing the change policy (Step S202). Next, the change policy generating unit 102 retrieves a sharing condition that is defined by an operation policy, and decides a resource for the change (Step S203).

Next, the SLA determining unit 104b acquires an operation policy of a tenant that shares the resource (Step S204). Next, the SLA determining unit 104b acquires a change flow that is in a process-waiting state from the change flow managing unit 107 (Step S205). Next, the SLA determining unit 104b extracts a time zone that may be changed for each of a resource and/or a service to be changed from an operation policy, a change policy, and a flow that is in a process-waiting state of a tenant (Step S206).

Next, the SLA determining unit 104b compares, for example, the time zone with the use start time of another tenant and outputs the presence or absence of a temporally-impossible change as a risk via the risk evaluation result output unit 105 (Step S207).

Next, the SLA determining unit 104b determines whether a risk exists. When it is determined that a risk exists (Step 5208: YES), the process control moves to Step S210. When it is determined that a risk does not exist (Step 5208: NO), the change flow generating unit 106 generates a change flow by turning the change policy into a sequence of steps, and stores the change flow in the change flow managing unit 107 as a change flow that is in a process-waiting state (Step S209).

Next, the change flow managing unit 107 determines whether the managed change flow in a process-waiting state arrives at an execution time (Step S210). When it is determined that the managed change flow in a process-waiting state arrives at an execution time (Step S210: YES), the change flow managing unit 107 outputs the corresponding change flow to the change flow execution device 300 so as to execute the change flow (Step S211). When Step S211 is terminated, the management process of configuration items according to the second embodiment is terminated.

According to the management process of configuration items of the second embodiment, because the change risk of the change policy of a tenant that is a new change target is evaluated considering the change of a logical configuration item by a change flow that is in a process-waiting state, the change risk of the change of a logical configuration item may be avoided even if the addition of a tenant, the addition or modification of a resource are frequent.

It has been explained about the embodiments of the present invention. However, the present invention is not limited to these. The present invention may be further realized by various different embodiments within the scope of the technical ideas that are described in the claims. Moreover, the effects of the present invention are not limited to those described in the embodiments.

Moreover, among the processes described in the present embodiments, the whole or a part of processes that have been automatically performed may be manually performed. Alternatively, the whole or a part of processes that have been manually performed may be automatically performed in a known method. Also, processing procedures, control procedures, specific titles, and information including various types of data and parameters, which are described in the present embodiments, may be arbitrarily changed if not specified otherwise.

Moreover, each component of each device illustrated in the drawings is a functional concept. Therefore, these components are not necessarily constituted physically as illustrated in the drawings. In other words, the specific configuration of dispersion/integration of each device is not limited to the illustrated configuration. Therefore, all or a part of each device may dispersed or integrated functionally or physically in an optional unit in accordance with various types of loads or operating conditions.

Specifically, in the first embodiment and the second embodiment, the dynamic tenant management device 100a and the dynamic tenant management device 100b are configured as devices that are separated from the logical-physical FCMDB. However, the present invention is not limited to this. The devices may be mounted on the same device.

Furthermore, all or a part of the process functions performed by each device may be realized by a CPU (Central Processing Unit) (or microcomputer such as MPU (Micro Processing Unit) or MCU (Micro Controller Unit)) and a program that is analyzed and executed by the CPU (or microcomputer such as MPU or MCU), or may be realized by a hardware by wired logic.

Furthermore, the configuration item management method described in the present embodiments can be realized by executing a program prepared beforehand with a computer such as a personal computer or a workstation. The program can be distributed via a network such as Internet. Moreover, the program can be recorded in a non-transitory computer readable recording medium, which can be read by a computer, such as a hard disk, a ROM, a RAM, a flexible disk (FD), a CD-ROM, an MO, or a DVD and can be executed by being read from the recording medium by the computer.

As described above, according to the configuration item management program, the configuration item management device, and the configuration item management method according to an aspect of the present invention, it is possible to facilitate the addition of a user or the modification and deletion of an operation policy of a user with respect to configuration items, and to ensure security and scalability of configuration item management.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer readable storage medium having stored therein a configuration item management program which causes a computer to execute a process comprising:
receiving, from a logical-physical configuration database that manages a correspondence relationship between a logical configuration item database that manages a configuration item including an operation policy of an operation target device for each user and a physical configuration item database that is a physical implementation of the logical configuration item database, an input of a relevant operation policy of a user who changes the operation policy;
generating a change policy by which the operation policy of the user received at the receiving is changed; and
evaluating an influence that is given to an operation policy of another user by the change policy of the user generated at the generating, to determine whether to execute the change policy and to output the influence to the operation policy of the other user.

2. The computer readable storage medium according to claim 1, wherein the process further comprises
further generating, when it is determined to execute the change policy at the evaluating, a change flow for changing the operation policy of the user, which is managed by the logical configuration item database and the physical configuration item database, in accordance with the change policy generated at the generating.

3. The computer readable storage medium according to claim 2, wherein the change flow includes execution schedule information in which time and date at which the change flow is executed is designated.

4. The computer readable storage medium according to claim 2, wherein the process further comprises
storing and managing the change flow generated at the further generating before executing the change flow, and
the evaluating includes comparing a change policy newly generated at the generating and the change flow managed at the storing and managing and evaluating an influence that is given to an operation policy of another user by the generated new change policy, to determine whether to execute the generated new change policy and to output the influence that is given to the operation policy of the other user.

5. The computer readable storage medium according to claim 4, wherein the storing and managing includes outputting the change flow managed to a change flow execution device in accordance with execution schedule information in which time and date at which the change flow is executed is designated.

6. A configuration item management device comprising:
an operation policy receiving unit that receives, from a logical-physical configuration database that manages a correspondence relationship between a logical configuration item database that manages a configuration item including an operation policy of an operation target device for each user and a physical configuration item database that is a physical implementation of the logical configuration item database, an input of a relevant operation policy of a user who changes the operation policy;
a change policy generating unit that generates a change policy by which the operation policy of the user received by the operation policy receiving unit is changed; and
an influence evaluating/determining/outputting unit that evaluates an influence that is given to an operation policy of another user by the change policy of the user generated by the change policy generating unit, to determine whether to execute the change policy and to output the influence to the operation policy of the other user.

7. The configuration item management device according to claim 6, further comprising
a change flow generating unit that generates, when the influence evaluating/determining/outputting unit determines to execute the change policy, a change flow for changing the operation policy of the user, which is managed by the logical configuration item database and the physical configuration item database, in accordance with the change policy generated by the change policy generating unit.

8. The configuration item management device according to claim 7, wherein the change flow includes execution schedule information in which time and date at which the change flow is executed is designated.

9. The configuration item management device according to claim 7, further comprising
a change flow managing unit that stores and manages the change flow generated by the change flow generating unit before executing the change flow, wherein
influence evaluating/determining/outputting unit compares a change policy newly generated by the change policy generating unit and the change flow managed by the change flow managing unit, and evaluates an influence that is given to an operation policy of another user by the generated new change policy, to determine whether to execute the generated new change policy, and outputs the influence that is given to the operation policy of the other user.

10. The configuration item management device according to claim 9, wherein the change flow managing unit outputs the change flow managed to a change flow execution device in accordance with execution schedule information in which time and date at which the change flow is executed is designated.

11. A configuration item management method comprising:
receiving, from a logical-physical configuration database that manages a correspondence relationship between a logical configuration item database that manages a configuration item including an operation policy of an operation target device for each user and a physical configuration item database that is a physical implementation of the logical configuration item database, an input of a relevant operation policy of a user who changes the operation policy;
generating a change policy by which the operation policy of the user received at the receiving is changed; and
evaluating an influence that is given to an operation policy of another user by the change policy of the user generated at the generating, to determine whether to execute the change policy and to output the influence to the operation policy of the other user.

12. The configuration item management method according to claim 11, further comprising
further generating, when it is determined to execute the change policy at the evaluating, a change flow for changing the operation policy of the user, which is managed by the logical configuration item database and the physical configuration item database, in accordance with the change policy generated at the generating.

13. The configuration item management method according to claim 12, wherein the change flow includes execution schedule information in which time and date at which the change flow is executed is designated.

14. The configuration item management method according to claim 12, further comprising
storing and managing the change flow generated at the further generating before executing the change flow, and
the evaluating includes comparing a change policy newly generated at the generating and the change flow managed at the storing and managing and evaluating an influence that is given to an operation policy of another user by the generated new change policy, to determine whether to execute the generated new change policy and to output the influence that is given to the operation policy of the other user.

15. The configuration item management method according to claim 14, wherein the storing and managing includes outputting the change flow managed to a change flow execution device in accordance with execution schedule information in which time and date at which the change flow is executed is designated.
